(19) United States
(12) Patent Application Publication
(10) Pub. No.: US 2014/0331899 A1
(43) Pub. Date: Nov. 13, 2014

(54) ACCELERATOR

(71) Applicant: SIKA TECHNOLOGY AG, Baar (CH)

(72) Inventors: Franz Wombacher, Jonen (CH); Beat Marazzani, Oberengstringen (CH); Christian Bürge, Schafisheim (CH); Christophe Kurz, Endingen (CH); Gilbert Mäder, Marthalen (CH)

(21) Appl. No.: 14/358,158

(22) PCT Filed: Dec. 21, 2012
(86) PCT No.: PCT/EP2012/076715

§ 371 Date: May 14, 2014

(30) Foreign Application Priority Data
Dec. 23, 2011 (EP) 11195531.6

(51) Int. Cl. C04B 22/00

(52) U.S. Cl. CPC C04B 22/00
USPC 106/638; 106/819

(57) ABSTRACT

The invention relates to additives for hydraulic binders and systems such as concrete and mortar produced therefrom. More particularly, the present invention relates to a setting and curing accelerator for hydraulic binders produced by reacting a calcium compound CV with a silica sol SL.

### TECHNICAL FIELD

The invention relates to additives for hydraulic binders and systems such as concrete and mortar produced therefrom. More particularly, the present invention relates to a setting and curing accelerator for hydraulic binding agents produced by reacting a calcium compound CC with silica sol SL, and to the production thereof.

### PRIOR ART

In an increasing number of cases, when precast concrete elements or precast reinforced concrete elements are used or in roadway or runway restoration projects, high early strength is becoming a requirement, so that the precast elements can be removed from the formwork, transported, stacked or prestressed or so that the roadways or runways can be used after only several hours. In addition to high-performance concrete formulations, such as those having a low wic value or a high cement content, thermal or steam treatments are frequently used to achieve this goal in practice. These treatments require a large amount of energy, and therefore, due to rising energy costs, substantial investment costs and problems with durability and with exposed concrete, such treatments are increasingly being dispensed with and other methods for accelerating the curing process are being sought.

In the past, accelerating additives have not been considered a satisfactory alternative to thermal or steam treatment. There are some known substances that accelerate the setting and curing of concrete and contain calcium compounds reacted with selected silicon dioxide compounds. For instance, DE202009017741 describes the use of an accelerating additive that contains calcium compounds reacted with pyrogenic silicic acid or precipitated silicic acid. However, these types of accelerating additives have the disadvantage that they result in an unsatisfactory compressive strength of the cured concrete.

### DESCRIPTION OF THE INVENTION

The object of the present invention is therefore to provide accelerating additives and methods for producing said additives which do not have the above-described disadvantages.

Unexpectedly, it has been found that this can be achieved by the method for producing a setting and curing accelerator for hydraulic binders according to claim 1.

Further aspects of the invention are the subject matter of additional independent claims. Particularly preferable embodiments of the invention are the subject matter of the dependent claims.

### IMPLEMENTATION OF THE INVENTION

In a first aspect, the present invention comprises a method for producing a setting and curing accelerator, hereinafter also referred to as an accelerator, for hydraulic binders, said method comprising a step:
(i) for reacting a calcium compound CC with silica sol SL.

The calcium compound CC is typically selected from the group consisting of calcium chloride, calcium nitrate, calcium formate, calcium acetate, calcium bicarbonate, calcium bromide, calcium citrate, calcium chlorate, calcium hydroxide, calcium oxide, calcium hypochloride, calcium iodate, calcium iodide, calcium lactate, calcium nitrite, calcium phosphate, calcium propionate, calcium sulfate, calcium sulfate hemihydrate, calcium sulfate dihydrate, calcium sulfide, calcium tartrate, calcium gluconate, calcium sulfamate, calcium maleate, calcium fumarate, calcium adipate and calcium aluminate. Preferably, the calcium compound CC is selected from the group consisting of calcium nitrate and calcium sulfamate.

It can further be advantageous for the calcium compound CC to be calcium nitrate, as this is advantageous particularly for high compressive strength, in particular, for a high compressive strength after 8 hours, in hydraulic binders.

It can further be advantageous for the calcium compound CC to be calcium sulfamate, as this is advantageous particularly for a high slump value, in particular, for a high slump value after 1 minute, in hydraulic binders.

In the present document, the term “silica sol”, also called kieselsol or silicic acid sol, refers to an aqueous solution of approximately spherical, colloidally dissolved polysilicic acid molecules having an SiO₂ content of 30-60%, which can be held in storage for years without alteration. Depending upon the particle size of the particles, silica sol ranges from milky/opaque to colorless/clear. The average particle diameter measures 1-150 nm. Production is carried out, for example, by treating aqueous alkali silicate solutions, also referred to as water glass, with ion exchangers and stabilizing these with a small amount of alkali.

In the present document, the term “water glass” is understood to refer to water soluble salts of silicic acids, in particular, potassium silicates and sodium silicates or aqueous solutions thereof, which have hardened from the molten mass, such as are described in the CD Römpp's Chemical Lexicon, Version 1.0, Georg Thieme Verlag, Stuttgart 1995.

Silica sol is distinguished, for example, from pyrogenic silicic acid, which includes highly disperse silicic acids that are produced by means of flame hydrolysis. In this process, silicon tetrachloride is decomposed in an oxyhydrogen flame:

Silica sol is also distinguished, for example, from precipitated silicic acid. These are produced from an aqueous alkali silicate solution by precipitation with mineral acids. In this process, colloidal primary particles are formed, which agglomerate as the reaction progresses and ultimately grow together to form aggregates.

Preferably, the silica sol SL has a pH of 3-9, in particular, of 5-7. This is advantageous because in hydraulic binders, it results in both high compressive strength, particularly high compressive strength after 8 hours, and a high slump value, particularly a high slump value after 1 minute.

If the silica sol SL has a pH level of 7-9, this is conducive to achieving a particularly high compressive strength in hydraulic binders.

If the silica sol SL has a pH level of 3-5, this is conducive to achieving an advantageous slump value in hydraulic binders.

The silica sol SL is preferably a silica sol having an average particle diameter of 1-150 nm, in particular, of 1-50 nm, preferably of 1-15 nm, most preferably of 1-5 nm.

This results in high compressive strength after 8 hours, particularly when the accelerator is used in hydraulic binders.

The reaction of the calcium compound CC with the silica sol SL in step (i) preferably takes place in the presence of water, particularly in water.

It is further advantageous for the calcium compound CC and the silica sol SL to be added to the water separately.

The reaction in step (i) preferably takes place in a liquid phase reactor selected from the group consisting of a sulzer mixer reactor, a reactor with external recirculation, a cascade reactor, a loop reactor, a stirred reactor and a reactor having a rotor/stator mixer. Preferred liquid phase reactors are, in particular, stirred reactors, static mixers and reactors having a rotor/stator mixer.

The following molar ratios are preferably present during the course of the reaction of step (i): Ca²⁺: SiO₂=0.1-2.5, preferably 0.15-2.3. This results in high compressive strength after 8 hours, particularly when the accelerator is used in hydraulic binders.

If the calcium compound CC is calcium nitrate, the molar ratio of Ca²⁺: SiO₂ during the reaction in step (i) is preferably =0.15-0.6, particularly preferably 0.2-0.4. This is particularly advantageous for achieving an advantageous slump value in hydraulic binders while simultaneously achieving high compressive strength after 8 hours.

If the calcium compound CC is calcium sulfamate, the molar ratio of Ca²⁺: SiO₂ during the reaction in step (i) is preferably =0.1-2.5, more preferably 1.5-2.5, particularly preferably 2.0-2.5. This is advantageous particularly for achieving high compressive strength after 8 hours.

If the calcium compound CC is calcium sulfamate, a molar ratio of Ca²⁺: SiO₂ during the reaction in step (i) of 0.1-2.5, preferably 0.1-1.5, particularly preferably 0.1-0.5 is advantageous, as this is conducive to an advantageous slump value in hydraulic binders.

During the reaction in step (i), a compound selected from the group consisting of aluminum salt, aluminum hydroxide, aluminum oxide, magnesium salt, magnesium hydroxide and magnesium oxide can also be added, with these salts particularly being selected from the group consisting of nitrates and nitriles.

It can further be advantageous for the method to comprise a further step (ii) for adding 1-10 wt/%, preferably 2-8 wt/%, particularly preferably 4 -8 wt/% N-methyldiethanolamine, referred to the total weight of the setting and curing accelerator. It has unexpectedly been found that this has an advantageous effect on compressive strength after 8 hours. It has further unexpectedly been found that the N-methyldiethanolamine improves the stability in storage of the setting and curing accelerator.

It can further be advantageous for the method to comprise a further step (iii) for adding a thickening agent, particularly selected from the group consisting of cellulose ether, polysaccharides, starch derivatives, polyvinyl alcohols, polyacrylamides and polyacrylates, with the thickening agent particularly being polyacrylates, and/or a further step
(iv) for adding a compound selected from the group consisting of amino alcohols, hydroxycarboxylic acids, alkali (earth) thiocyanates, alkali (earth) halides and glycerin compounds.

An addition of a dispersing agent selected from the group consisting of polycarboxylates, melamine formaldehyde condensates, naphthalene sulfonates, lignin sulfonates and polyoxyalkylenes can also be advantageous, with the mixing ratio, as a percentage by weight of the active substances, preferably being: dispersing agent: silica sol SL=0.01-30, preferably 1-10, particularly preferably 1.5-5.0.

However, it can also be advantageous for none of the aforementioned dispersing agents to be added.

In the method, step (i) is typically carried out at a temperature of −10-90° C., at a pH of 4-9, and at a pressure of 0.8-20 bar.

It is particularly advantageous in terms of the early strength that results from the accelerator for the method to comprise a further step (v) in which the reaction product from step (i) is comminuted. In particular, step (v) involves comminution using agitation mills, rolling mills, colloid mills, rotor/stator mixers and/or homogenizers, preferably using rotor/stator mixers and/or homogenizers.

Step (v) preferably results in an average particle size of the reaction product of 1000-10 nm, preferably of 100-10 nm. This is advantageous particularly for the early strength that is brought about by the accelerator.

In a further aspect, the present invention relates to a setting and curing accelerator, produced according to any of the above-described methods. The setting and curing accelerator is preferably provided as a powder, particularly as a colloid, a suspension or an aqueous solution.

The setting and curing accelerator according to the invention can be used in various fields, particularly in the concrete and cement industry. The accelerator has particularly efficacious properties as an accelerator for hydraulically setting compositions, in other words, it can be used for accelerating the setting and curing of hydraulic binders, particularly in quick-setting cement, and for the mortar or concrete produced therefrom. The accelerator according to the invention can also be used to produce mortar or concrete which has high early and final strength. Therefore, the setting and curing accelerator according to the invention is particularly suitable when the hydraulically setting composition needs to be able to withstand loads or be traveled on very soon after application, for example, in road or bridge construction, with the prefabrication of concrete elements, with precast concrete and precast reinforced concrete elements, or with runway restoration projects, particularly for airport runways, so that the precast elements can be removed from the formwork, transported, stacked or prestressed or so that the roadways or runways can be used after only several hours.

In principle, any hydraulically setting substances that are known to a person skilled in the art of concrete can be used as hydraulically setting systems or compositions. More particularly, these are hydraulic binders such as cements, for example, Portland cements or aluminous cements, and mixtures thereof with fly ash, silica fume, slag, blast furnace sands and limestone filler. Additional hydraulically setting substances in the present invention refers to burnt lime. Cement is preferred as the hydraulically setting composition. Also possible are aggregates such as sand, gravel, stones, ground quartz, chalk, and constituents that are traditionally used as additives, such as concrete liquefiers, for example, lignosulfonates, sulfonated naphthalene formaldehyde condensates, sulfonated melamine formaldehyde condensates or polycarboxylate ethers, accelerators, corrosion inhibitors, retarding agents, shrinkage reducers, defoaming agents or pore formers.

The accelerator according to the invention can be used both in liquid and in solid form, either alone or as a constituent of an additive, for the use according to the invention. The invention therefore also relates to an additive in liquid or solid form comprising at least one accelerator according to the invention.

To improve processability and to extend the processing time after the addition of the accelerator according to the invention to a hydraulic binder, the additive also preferably contains a liquefier, in addition to the accelerator. Possible liquefiers include lignosulfonates, sulfonated naphthalene formaldehyde condensates, sulfonated melamine formaldehyde condensates, sulfonated vinyl copolymers or polycarboxylate liquefiers, such as are known in concrete chemistry, for example, as high-performance liquefiers, or mixtures thereof.

The accelerator or the additive containing the accelerator can also contain additional constituents. Examples of additional constituents include solvents, in particular water, or additives, such as additional accelerating substances, for example, thiocyanates, nitrates or aluminum salts, acids, or salts thereof, or amine-containing substances such as alkanolamines, retarding agents, shrinkage reducers, defoaming agents or foaming agents.

If the accelerator according to the invention or the additive containing the accelerator will be used in liquid form, a solvent is preferably used for the reaction. Preferred solvents include hexane, toluene, xylene, methylcyclohexane, cyclohexane or dioxan, for example, and alcohols, particularly ethanol or isopropanol, and water, with water being the most preferable solvent.

The accelerator according to the invention or the additive containing the accelerator can also be provided in a solid state of aggregation, for example as powder, flakes, pellets, granulate or plates, and can be readily transported and stored in this form.

The accelerator according to the invention can be provided in the solid state of aggregation, for example, and can be mixed with a liquefier, which is likewise provided in the solid state of aggregation, allowing it to be stored or transported for extended periods of time.

The accelerator according to the invention or the additive containing the accelerator, in the solid state of aggregation, can also be a constituent of a cement composition, a so-called dry mixture, which can be stored for extended periods of time, and is typically packaged in bags or stored in silos and used.

The accelerator according to the invention or the additive containing the accelerator can also be added to a conventional concrete composition at the same time the water is added, or shortly before or shortly after this. The addition of the accelerator according to the invention in the form of an aqueous solution or dispersion, particularly as mixing water or as a component of the mixing water or as part of a liquid additive which is added with the mixing water to the hydraulic binder, has proven particularly suitable.

The accelerator according to the invention or the additive can also be sprayed in liquid form onto the binder, the concrete, the mortar, and non-hydraulic additives, before or after grinding of the hydraulic or latent hydraulic binder. For example, the hydraulic binder can be partially coated with the accelerator or with the additive containing the accelerator. This enables the production of a hydraulic binder, in particular cement or latent hydraulic slag, which already contains the accelerator or the additive containing the accelerator and can therefore be stored and sold as a finished mixture, for example as so-called quick-setting cement. Once the mixing water has been added, this cement has the desired properties of fast setting and high early strength, without requiring that another additive in addition to the mixing water be added at the building site.

In a further aspect, the present invention relates to a mixture containing a binder, comprising at least one hydraulically setting binder and at least one setting and curing accelerator according to the invention. Suitable binders include, for example, cement, particularly Portland cements or aluminous cements, and mixtures thereof with fly ash, silica fume, slag, blast furnace sands, gypsum and limestone filler, or burnt lime, a latent hydraulic powder or inert microscopic powder. Preferred mixtures that contain binders are concrete compositions.

The mixture can also contain additional aggregates such as sand, gravel, stones, ground quartz, chalk, and constituents that are traditionally used as additives, such as concrete liquefiers, for example, lignosulfonates, sulfonated naphthalene formaldehyde condensates, sulfonated melamine formaldehyde condensates or polycarboxylate ethers (PCE), accelerators, corrosion inhibitors, retarding agents, shrinkage reducers, defoaming agents or pore formers.

The mixture that contains binders preferably contains at least one liquefier, preferably a liquefier having a polycarboxylate ether (PCE) base, in addition to the accelerator.

The accelerator according to the invention is preferably used in a quantity of 0.01 to 30 wt/%, preferably of 0.1 to 10 wt/%, referred to the weight of the binder, in order to achieve the desired effect. Multiple combined accelerators may also be used in order to achieve the desired effect.

In a further aspect, the present invention relates to a method for producing a mixture that contains a binder, wherein the at least one accelerator according to the invention is added in solid or liquid form to the binder, separately or premixed as an additive.

In a further aspect, the present invention relates to a method for accelerating the setting and curing of hydraulic binders and of mortar or concrete produced therefrom, wherein a setting and curing accelerator according to the invention is added to a mixture that contains hydraulic binders, in a quantity of 0.01 to 30 wt/%, preferably of 0.2 to 20 wt/%, particularly preferably of 0.1 to 10 wt/%, referred to the weight of the hydraulic binder.

The present invention provides an additive for hydraulic binders and a method for producing said additive, which accelerates the setting and curing process of the hydraulic binders, without negatively impacting the processing times, the strength development or the durability of the mortar or concrete compositions produced using these. Therefore, the additive according to the invention and particularly the setting and curing accelerator according to the invention is particularly suitable when the hydraulically setting composition needs to be able to withstand loads or be traveled on very soon after application, for example, in road or bridge construction, with the prefabrication of concrete elements, with precast concrete and precast reinforced concrete elements, or with runway restoration projects, particularly for airport runways. As a result, the precast elements can be removed from the formwork, transported, stacked or prestressed or the roadways or runways can be used after only several hours.

### EMBODIMENT EXAMPLES

Raw Materials Used

TABLE 1
Characterization and designation of raw materials used.

| | | |
|---|---|---|
| CC1 | Ca(NO₃)₂ × 4 H₂O | Yara GmbH & Co, |
| | | Germany |
| CC2 | Ca(O—SO₂—NH₂)₂ | Sika Technology AG |
| SL | Cembinder 110, particle size 2.5 nm, | AkzoNobel, Sweden |
| | pH 6, colloidally dissolved polysilicic | |
| | acid molecules having a 7.2% SiO₂ | |
| | content | |
| GK | Precipitated silicic acid, Sipernat 500, | Evonik Degussa |
| | particle size 6 μm, pH 6, water | Germany |
| | content ≦3% | |
| PK | Pyrogenic silicic acid, Aerosil-380, | Evonik Degussa |
| | particle size 7 nm, pH (4% | Germany |
| | dispersion) 4.2, water content ≦2% | |
| PCE | Polycarboxylic acid with | Sika Schweiz AG, |
| | polyoxyalkylene side chains, water | Switzerland |
| | content 60% | |
| CF | Calcium formate, curing accelerator | Amik, Italy |
| MDEA | N-methyldiethanolamine, curing | BASF, Switzerland |
| | accelerator | |
| GL | Glycerin | Impag AG, Switzerland |
| CM | Carbomer 940, polyacrylic acid | Lubrizol, Belgium |
| | polymer, thickening agent | |

Production of the Additive

according to the invention and comparison compounds were produced according to the methods described below, wherein the raw materials used according to Table 1 were used in the ratios described in Table 2.

Method for Producing the Accelerator

The quantities of CC described in Table 2 were dissolved in water in a 2 liter beaker. The indicated quantity of SL was then added over a period of one hour. The contents of the 2 liter beaker were stirred using a blade agitator

(RW 20.n, Ika Labortechnik) having a blade agitator diameter of 5 cm, at 500 to 2000 rpm, while the SL was being added, and then for an additional 15 minutes. The contents were then homogenized for 30 seconds using a rotor/stator mixer (PT2100, Polytron, Kinematica, Switzerland). After mixing with the rotor/stator mixer, the contents were stirred for another 15 minutes using a blade agitator (model as described above). The pH of the SL was 6.0, with the exception of B13, in which the pH=4.0, and B15, in which the pH=8.3.

In the case of accelerator B9, PCE (2.94 wt/%), GL (3.32 wt/%), CF (12.02 wt/%), CM (0.2 wt/%) and MDEA (2 wt/%) were also added. Addition after rotor/stator mixer.

In the case of accelerators B13-B15, 6 wt/% MDEA was also added. Addition after rotor/stator mixer.

Mortar Tests

The efficacy of accelerators B1-B15 according to the invention and of comparison examples VB1 and VB2 was tested in mortar.

| Composition of the mortar mixture (MM): | |
|---|---|
| (largest particle 8 mm) | Quantity in g |
| Portland cement (SVW CEM I 42.5N) | 750 |
| Limestone filler | 141 |
| Sand 0-1 mm | 738 |
| Sand 1-4 mm | 1107 |
| Sand 4-8 mm | 1154 |

As cement, SVW (Swiss cement types Siggenthal, Vigier, Wildegg, 1:1:1 mixture) CEM I 42.5N was used, which has a fineness according to Blaine of approximately 3400 cm²/g.

The sands, the fillers and the cement were mixed dry for 1 minute in a Hobart mixer. The mixing water, in which the accelerator was dissolved or dispersed, was added over a period of 10 seconds, and this was mixed for another 170 seconds. The entire wet mixing time was 3 minutes. The water/cement value (w/c value) was 0.4.

Another 1 wt/% (referred to the cement weight) of a liquefier (Sika ViscoCrete 3081S, available from Sika Schweiz AG, Switzerland) was added to all mortars, in order to improve the processability of the mortar mixtures.

To determine the efficacy of the accelerator according to the invention, the mortar mixtures MM were combined with the various accelerators from Table 2 (see Table 3).

Mortar compositions (MC) MC4-MC6, MC9-MC13, MC15-MC17 and MC19-MC21 represent examples according to the invention, whereas mortar compositions MC1-MC3, MC7, MC14 and MC18 represent comparison examples.

To determine the efficacy of the accelerator according to the invention or of the additive, the slump value (SV) and the compressive strength were determined in Table 3.

TABLE 2

| Accelerator (A) | CC, wt/%* | SiO₂ Source, wt/%* | Ca²⁺:SiO₂ |
|---|---|---|---|
| CA1 | CC1, 50.47 | GK, 2.65 | 1:0.31 |
| CA2 | CC1, 50.47 | PK, 2.65 | 1:0.31 |
| A1 | CC1, 36.87 | SL, 53.88 | 1:0.62 |
| A2 | CC1, 50.47 | SL, 36.88 | 1:0.31 |
| A3 | CC1, 61.87 | SL, 22.61 | 1:0.16 |
| A4 | CC1, 25.33 | SL, 36.88 | 1:0.62 |
| A5 | CC1, 31.61 | SL, 36.88 | 1:0.5 |
| A6 | CC1, 37.9 | SL, 36.88 | 1:0.41 |
| A7 | CC1, 44.18 | SL, 36.88 | 1:0.35 |
| A8 | CC1, 50.47 | SL, 36.88 | 1:0.31 |
| A9 | CC1, 40.15 | SL, 29.34 | 1:0.3 |
| A10 | CC2, 25.7 | SL, 14.2 | 1:0.23 |
| A11 | CC2, 15.8 | SL, 47.0 | 1:1.24 |
| A12 | CC2, 11.5 | SL, 61.7 | 1:2.24 |
| A13 | CC1 47.4 | SL, 34.7, pH 4.0 | 1:0.3 |
| A14 | CC1 47.4 | SL, 34.7, pH 6.0 | 1:0.3 |
| A15 | CC1 47.4 | SL, 34.7, pH 8.3 | 1:0.3 |

*= wt/%, referred to the total weight of accelerator B

TABLE 3

| | | | Compressive strength (in | |
|---|---|---|---|---|
| | | SV (in %) after 1 min. | %) | |
| | Accelerator/wt/ | as compared with | 8 hours as compared with | |
| | %* | MC1 | MC1 | Ca²⁺:SiO₂ |
| MC1 | — | 100 | 100 | — |
| MC2 | CA1/0.71 | 105 | 156 | 1:0.31 |
| MC3 | CA2/0.71 | 109 | 161 | 1:0.31 |
| MC4 | A1/0.71 | 76 | 211 | 1:0.62 |
| MC5 | A2/0.71 | 78 | 240 | 1:0.31 |
| MC6 | A3/0.71 | 94 | 214 | 1:0.16 |
| | | | Compressive strength (in | |
| | | SV (in %) after 1 min. | %) | |
| | Accelerator/wt/ | as compared with | 8 hours as compared with | |
| | %* | MC7 | MC7 | Ca²⁺:SiO₂ |
| MC7 | — | 100 | 100 | — |
| MC9 | A4/0.71 | 85 | 137 | 1:0.62 |
| MC8 | A5/0.71 | 91 | 183 | 1:0.5 |
| MC10 | A6/0.71 | 95 | 213 | 1:0.41 |
| MC11 | A7/0.71 | 96 | 260 | 1:0.35 |
| MC12 | A8/0.71 | 98 | 370 | 1:0.31 |
| MC13 | A9/0.71 | 109 | 463 | 1:0.3 |
| | | | Compressive strength (in | |
| | | SV (in %) after 1 min. | %) | |
| | Accelerator/wt/ | as compared with | 8 hours as compared with | |
| | %* | MC14 | MC14 | Ca²⁺:SiO₂ |
| MC14 | — | 100 | 100 | — |
| MC15 | A10/0.71 | 106 | 139 | 1:0.23 |
| MC16 | A11/0.71 | 79 | 133 | 1:1.24 |
| MC17 | A12/0.71 | 70 | 183 | 1:2.24 |
| | | | Compressive strength (in | |
| | | SV (in %) after 1 min. | %) | |
| | Accelerator/wt/ | as compared with | 8 hours as compared with | Ca²⁺:SiO₂/ |
| | %* | MC18 | MC18 | pH SL |
| MC18 | — | 100 | 100 | — |
| MC19 | A13/0.72 | 117 | 467 | 1:0.3/ |
| | | | | pH 4.0 |
| MC20 | A14/0.72 | 103 | 489 | 1:0.3/ |
| | | | | pH 6.0 |
| MC21 | A15/0.72 | 104 | 511 | 1:0.3/ |
| | | | | pH 8.3 |

*= wt/%, referred to the total weight of the mortar composition MC (including mixing water), slump value (SV) after 1 minute (min).

The slump value (SV) of the mortar was determined in accordance with EN 1015-3. The determination was made after 1 min. The test to determine compressive strength (in N/mm²) was carried out using prisms (40×40×160 mm) after 8 hours according to EN 196.1 and EN 12190.

For use in road or bridge construction, with the prefabrication of concrete elements with precast concrete and precast reinforced concrete elements or with runway restoration projects, where the precast elements must be removed from the formwork, transported, stacked or prestressed or the roadways or runways must be usable after only several hours, high strength values after 8 hours are extremely important.

The results of MC1-MC6 show that mortar compositions MC3 to MC6, which contain accelerators comprising silica sol SL and calcium nitrate CC1, have improved compressive strength after 8 hours as compared with the mortar compositions MC1 and MC2, which have accelerators comprising calcium nitrate CC1 and precipitated silicic acid, or pyrogenic silicic acid. The same behavior was also found (not shown) as compared with accelerators comprising CC2 in place of CC1.

In addition, mortar compositions were tested which contained accelerators according to the invention, the SL of which have an average particle diameter of 2.5 nm, 5 nm, 7 nm, 12 nm, 30 nm, 40 nm or 50 nm. It was found that the mortar compositions have a higher compressive strength after 8 hours, the smaller the average particle diameter of the SL of the accelerator was.

1. A method for producing a setting and curing accelerator for hydraulic binders, having a step:
(i) for reacting a calcium compound CC with silica sol SL.

2. The method according to claim 1, wherein in step (i), the reaction of the calcium compound CC with silica sol SL is carried out in the presence of water.

3. The method according to claim 2, wherein the calcium compound CC and the silica sol SL are added to the water separately from one another.

4. The method according to claim 1, wherein the calcium compound CC is selected from the group consisting of calcium chloride, calcium nitrate, calcium formate, calcium acetate, calcium bicarbonate, calcium bromide, calcium citrate, calcium chlorate, calcium hydroxide, calcium oxide, calcium hypochloride, calcium iodate, calcium iodide, calcium lactate, calcium nitrite, calcium phosphate, calcium propionate, calcium sulfate, calcium sulfate hemihydrate, calcium sulfate dihydrate, calcium sulfide, calcium tartrate, calcium gluconate, calcium sulfamate, calcium maleate, calcium fumarate, calcium adipate and calcium aluminate.

5. The method according to claim 1, wherein, during the course of the reaction of step (i), the following molar ratios are present: Ca²⁺:SiO₂=0.1-2.5.

6. The method according to claim 1, wherein the calcium compound CC is calcium nitrate, and during the course of the reaction of step (1), the following molar ratios are present: Ca²⁺:SiO₂=0.15-0.6.

7. The method according to claim 1, wherein the calcium compound CC is calcium sulfamate, and during the course of the reaction of step (i), the following molar ratios are present: Ca²⁺:SiO₂=0.1-2.5.

8. The method according to claim 1, wherein the calcium compound CC is calcium sulfamate, and in that during the course of the reaction of step (i), the following molar ratios are present: Ca²⁺:SiO₂=0.1-2.5.

9. The method according to claim 1, wherein the silica sol SL has a pH of 3-9.

10. The method according to claim 1, wherein the silica sol SL is a silica sol having an average particle diameter of 1-150 nm.

11. The method according to claim 1, wherein the method further comprises a step (ii) for adding 1-10 wt/% N-methyldiethanolamine, referred to the total weight of the setting and curing accelerator.

12. The setting and curing accelerator produced in a method according to claim 1.

13. A mixture containing a binder and comprising at least one hydraulically setting binder and at least one setting and curing accelerator according to claim 12.

14. A method for accelerating the setting and curing of a hydraulic binder by adding a setting and curing accelerator, which is obtainable from a method according to claim 1, wherein a mixture which contains the specified hydraulic binder, 0.01 to 30 wt % of the setting and curing accelerator, referred to the weight of the specified hydraulic binder, is added.
